(19) United States
(12) Patent Application Publication
(10) Pub. No.: US 2021/0138464 A1
(43) Pub. Date: May 13, 2021

(54) Fluid Control Delivery Device and Method

(71) Applicant: Arm Limited, Cambridge (GB)

(72) Inventors: Emre Ozer, Buckden (GB); Milosch Meriac, Cambridge (GB); Hugo John Martin Vincent, Cambridge (GB)

(73) Assignee: Arm Limited, Cambridge (GB)

(21) Appl. No.: 17/052,990

(22) PCT Filed: May 7, 2019
(86) PCT No.: PCT/GB2019/051254

§ 371 Date: Nov. 4, 2020

(30) Foreign Application Priority Data
May 10, 2018 (GB) 1807636.4

(51) Int. Cl. B01L 3/00; G01N 15/06

(52) U.S. Cl. CPC B01L 3/502738; B01L 3/502715; G01N 15/06; B01L 2200/027; G01N 2015/0693; B01L 2300/0636; B01L 2300/049; B01L 2400/0487; B01L 2400/06; B01L 2200/0689

(57) ABSTRACT

A fluid delivery control device comprising; (i) at least one inlet portal to allow fluid passage into a chamber; (ii) at least one outlet portal to allow fluid passage from the chamber; (iii) at least one biosensor; (iv) at least one actuator; and wherein the at least one biosensor is in fluid communication with said fluid and is associated with a valve having actuator capability, the valve having actuator capability being in communication with sensor measured conditions upon which the valve permits or inhibits delivery of the fluid from the chamber.

### BACKGROUND

The present technology relates to a device and method to enable selective injection of fluids into devices such as microfluidic chips. In particular, the technology has real application to enable biosafe injection of fluids into smart microfluidic chips that can be implanted into a body for use in diverse biomedical applications.

A microfluidic chip is a lab-on-chip device comprising channels, mixers, chambers and valves. Channels are sub-millimetre in diameter and fluids can be directed, mixed and separated using the channel, chambers, mixers and valves. One type of microfluidic chip can be implemented onto a glass surface with channels engraved, another type can be fabricated using poly(dimethylsiloxane) PDMS moulded into channels, chambers and valves. In use, the chambers are reservoirs to keep sample assay and reagents; valves control the fluid flow in channels and mixers control the flow into chambers. The microfluidic chip has one or more inlets into which a fluid sample and reagents are pumped and may have one or more outlets from which the mixed fluid can leave. Applications of microfluidics are many: DNA extraction, on chip PCR, cell analysis, single cell imaging, drug delivery, pathogen detection, fuel cell power, food technology and mixing.

Having control over the delivery of the sample assay and reagents into a microfluidic chip would be beneficial to the efficient operation of the device.

### BRIEF DESCRIPTION OF THE DRAWINGS

Embodiments of the present technology will now be described, with reference to the accompanying drawings of which:

FIG. 1 is a schematic diagram of a smart microfluidic chip according to a first embodiment of the present technology.

FIG. 2 is a schematic diagram of a fluid delivery control device according to a second embodiment of the present technology;

FIG. 3 is a schematic diagram of a fluid delivery control device according to a third embodiment of the present technology;

FIG. 4 is a schematic diagram of a fluid delivery control device according to a fourth embodiment of the present technology;

FIG. 5 is a schematic diagram of a fluid delivery control device according to a fifth embodiment of the present technology; and

FIG. 6 is a schematic diagram of a fluid delivery device according to a sixth embodiment of the present technology.

### DETAILED DESCRIPTION

According to a first aspect of the present technology, there is provided a fluid delivery control device comprising: a chamber, at least one inlet portal to allow fluid passage into the chamber; at least one outlet portal to allow fluid passage from the chamber; at least one biosensor; at least one actuator; wherein the at least one biosensor is in communication with said fluid and is associated with a valve having actuator capability, the valve having actuator capability being in communication with sensor measured conditions upon which the valve permits or inhibits delivery of the fluid from the chamber.

The at least one biosensor may be located adjacent to or within the chamber. It may comprise a biosensor capable of detecting a fluid in the chamber, for example, by detecting a selected fluid parameter, and delivering an output to a control unit for the valve having actuator capability.

The at least one actuator may comprise a plurality of actuators wherein an actuator actuates the valve having actuator capability. The at least one actuator may include other actuators allowing passage of the fluid into and out of the chamber. The additional actuators may be located upstream or downstream from the chamber and may comprise a pump (such as a peristaltic pump) for assisting fluid flow into and/or out of the chamber.

The valve having actuator capability may be configured as a single valve and actuator unit or as separate valve and actuator units. When it is configured as a single valve and actuator unit, the valve having actuator capability responds to a selected fluid parameter and actuates valve opening or closing in a single operation. When the valve having actuator capability is configured as separate valve and actuator units, the valve unit will be located within the chamber whereby to permit or inhibit delivery of the fluid from the chamber and the actuator unit may be located outside the chamber.

The control unit may comprise a programmable microcontroller. The processor may be programmed with sensor conditions upon which the valve having actuator capability acts to permit or inhibit delivery of the fluid from the chamber.

The inlet portal, the outlet portal and the chamber may be comprised together as tube, pipe or other such conduit for a microfluidic chip. Alternatively, they may be comprised together by an injection device, such as a syringe.

The fluid delivery control device may, in particular, be provided on a smart microfluidic chip or it may be used upstream with a smart microfluidic chip.

A smart microfluidic chip is a microfluidic chip including at least one biosensor and at least one actuator which is provided with a control unit that is located with the microfluidic chip and coupled to the at least one actuator and the at least one biosensor and opens or closes at least one chamber, valve and/or mixer within the chip.

The control unit may comprise a programmable microcontroller or a custom HW specific to the application of the chip and may include a storage unit. The smart microfluidic chip may, for example, enable one or more micro-assays under the direction of the control unit.

In one embodiment, the fluid delivery control device comprises a smart microfluidic chip including a microfluidic inlet chamber within the chip and at least one biosensor capable of sensing a fluid in the inlet chamber and delivering an output to the control unit of the chip. In this embodiment, the valve having actuator capability may comprise separate or integrated valve and actuator units for an outlet from the inlet chamber to the interior of the chip which are responsive to the control unit to open or close the outlet from the inlet chamber and permit or inhibit (prevent) fluid flow to an interior of the chip.

In another embodiment, the fluid delivery control device is used in conjunction with a smart microfluidic chip. In this embodiment, the fluid delivery device comprises a chamber outside the chip and at least one biosensor capable of sensing a fluid in the chamber and delivering an output to a control unit of the chip. In this embodiment, the valve having actuator capability may comprise separate or integrated valve and actuator units for the chamber which are responsive to the control unit to open or close the chamber and permit or inhibit (prevent) fluid flow to the chip.

In this embodiment, the fluid delivery control device may, in particular, be configured as an inlet conduit or tube for the chip. In that case, the inlet conduit or tube defines a chamber (which may or may not be microfluidic) having an inlet portal and an outlet portal and the at least one biosensor and the valve having actuator capability may be provided, at least in part, within the chamber.

The smart microfluidic chip may be manufactured to be directly implantable in the human or animal body. Alternatively, it may be provided within an enclosure comprising a biocompatible material permitting its implant to the human or animal body.

In either case, the smart microfluidic chip may include an inlet conduit or tube and an outlet conduit or tube allowing for the passage of fluid from outside the human or animal body into and out of the smart microfluidic chip. The inlet conduit or tube may, in particular, comprise a fluid delivery control device for the chip.

The inlet and/or the outlet portal may be provided with a seal, for example a shutter, so that their ports can be opened and/or closed. The shutter may comprise a membrane. A shutter control actuator may communicate with the control unit whereby to close or open the shutter membrane. The seal(s) may serve to prevent contamination of a smart microfluidic chip.

In another embodiment, the fluid delivery device comprises a housing for receipt of a syringe and a syringe adapted to engage with the housing. The syringe may include a valve having actuator capability. The housing may include a sensor system comprising at least one biosensor and a control unit. The insertion of the syringe into the housing may cause the valve having actuator capability to align with the sensor system. The valve having actuator capability may be responsive to the control unit to open or close the valve when the syringe is inserted into the housing and prevent or permit the use of the syringe.

The valve having actuator capability may, in particular, be in a closed state when it is inserted into the housing. The sensor system may trigger the valve to open, for example, by way of an electromagnetic signal response and permit fluid flow out of the syringe.

In another embodiment, the fluid delivery control device comprises a syringe adapted to include a sensor system comprising at least one biosensor, a control unit and a valve having actuator capability. The sensor system may be provided on or within an exterior wall of the syringe and the valve having actuator capability may be located within the interior of the syringe. The valve having actuator capability may be responsive to the control unit to open or close the valve and prevent or permit the use of the syringe.

The valve having actuator capability may be in a closed state when it is inserted into the housing. It may, in particular, comprise a resilient lever provided on an interior wall of the syringe that engages with a notch or recess provided within the plunger of the syringe.

In embodiments, the valve having actuator capability may comprise one or more of a preloaded spring, decoupled magnets, flow meter and burst fuse. It may, in particular, comprise a coating on a spring that dissolves when it reacts with the drug or other liquid that is injected into the device. The reaction allows the spring to contract or expand when in contact with the correct fluid (opening and or closing valves etc.)—the dissolving fluid might be independent of the functional fluid in this case.

In embodiments, the at least one biosensor is selected to detect changes in one or more signals of the group signals consisting of electrochemical, optical, electronic, electro-chemiluminescent, fluorescent, bioluminescent, piezoelectric, gravimetric and pyroelectric signals.

The at least one biosensor may, in particular, comprise an array of light sensors, which may be located within or without the microfluidic chamber, adapted to detect the docking of marker molecules provided within the fluid.

The fluid delivery control device according to the present technology allows for checking of the fluid to be supplied to a microfluidic chip or the human or animal body. It may, in particular, allow a biosafe injection of fluid to an implantable smart microfluidic chip.

The checking of the fluid to be supplied may interrogate one or more of a broad range of fluid properties. Such properties may be measured by the at least one biosensor to trigger the operation of the valve having actuator capability.

A fluid may comprise a date code expiration, which can be coded within a synthetic DNA biomarker base pair coding to become an expiration date. In such a way, the fluid may dock with a DNA causing hybridisation and generation of a current or change in measurable impedance.

Alternatively, the active ingredient of the fluid may degrade into a certain protein after the expiration date, and this protein can be detected by its antibody that is anchored or functionalised to a surface of the chamber.

The detection can be done label-free where the antibodies are functionalised to the surface of a biosensing transistor or a series of transistors, and the biosensing transistors turn on when the protein molecules bonds with functionalised antibodies.

The detection can also be done with labels such as fluorescent or bioluminescent dyes. When the protein molecules bond with functionalised antibodies, the label fluoresces with an external light source such as LED if a fluorescent dye is used or luminesces if a bioluminescent dye is used.

In this case, the areas of the chip, for example, which are docked by marker molecules can be detected by an array of light sensors that can be also located outside of the testing chamber. These arrays can be 0D (sensor moving in a scanning fashion), 1D (camera line sensor) or 2D (traditional camera sensor)—optionally combined with focussing optics as part of the disposable housing or as part of the non-disposable sensor.

Any type of unique identifier can be generated from the combination and concentration of marker fluids and compared to database entries and until a matching response is found in the database, the valve may remain closed if needed. A whitelist of fluids may be kept, as well as a blacklist and fluids may be revoked from the white list or blocked.

A binary or multiary fluid may be used to identify particular fluids. A binary fluid comprises, in addition to the active ingredient of the fluid, an inert chemical composition that may serve no function other than to identify the particular fluid using a biomarker. By using multiple fluids their absence or presence can encode one bit in a multibit value. Thus, the binary value can be used to identify a class of fluid or even the serial-number ID of specific fluid instance. A list of fluids may be added to a whitelist of permitted fluids and also a blacklist of fluids may be drawn up.

The fluid delivery control device according to the present technology may determine an expiration date of an injection fluid and in the event of an expiration date being beyond a permitted date, the valve having actuator capability may remain closed. Additionally, or alternatively, it may have a geolocation attribute and may allow passage of fluids in specified locations only.

The fluid delivery control device according to the present technology has applications within a wide range of technical fields other than the medical field. It may, for example, be used with any mixing and, in particular, a process for the manufacture and/or analysis of food or beverages, chemicals or other industrial fluids.

According to a second aspect of the present technology, there is provided a valve for controlling delivery of a fluid in a fluid delivery system, the valve having a control system comprising at least one biosensor which is fluid communication with said fluid and which provides empirical data to a processor and an integral or discrete actuator which is in communication with the processor, the processor being programmed with conditions upon which the valve permits or inhibits delivery of the fluid from a chamber.

Embodiments in this aspect will be apparent from the embodiments described in relation to the first aspect of the present technology.

In a third aspect of the present technology, there is provided a method of delivering an exact/appropriate amount of fluid to a system the method comprising:
(i) assessing a level of a moiety in a fluid sample in a chamber obtained from a fluid flow using the device or valve according to to the first or second aspect of the present technology;
(ii) comparing the level of moiety present in the fluid derived from a readout of the device or valve to a standard value and/or a safe level;
(iii) allowing a programmed processor to determine if conditions are appropriate and feeding signals to a valve having actuator capability;

wherein, if conditions are inappropriate the valve will close to deny fluid passage to the system or if conditions are appropriate will allow fluid flow to the system.

The system may be a mammalian body, a fluid line in the food and beverage industry, a fluid line in a chemical process, a fluid line in an industrial process or a fluid line in a fluid control mixing process.

The assessment or determination of the moiety in the fluid sample may be either continuous or periodic.

The fluid may include a pre-mixed marker or a set of markers and the identifier may be generated from a combination of marker fluids types and/or concentration of marker fluids.

The identifier may, in particular, be read from a database and the valves remain closed until a matching response is made in the database. The database may comprise a white or blacklist of fluids.

The fluid may comprise a multiary fluid, whereby the absence or presence of a fluid type can encode one bit in a multibit value. The fluid may be selected from the group comprising a body fluid; blood, urine and plasma.

In a fourth aspect of the present technology, there is provided a method of assessing an exact/appropriate amount of a medicament ex vivo to be administered to an individual comprising:
(i) assessing a level of a moiety in a fluid sample in a chamber obtained from the medicament to be administered using the device or valve according to the first or second aspect of the present technology;
(ii) comparing the level of moiety present in the fluid derived from a readout of the device or valve to a standard value and/or a safe level;
(iii) allowing a programmed processor to determine if conditions are appropriate and feeding signals to a valve having actuator capability;

wherein, if conditions are inappropriate valves will close to deny fluid passage to the system or if conditions are appropriate will allow fluid flow to the system.

In a fifth aspect of the present technology, there is provided a kit comprising the device or valve according to the first or second aspects of the present technology and a chamber loaded with at least one therapeutic; a further reservoir of the therapeutic and an external/remote control system for topping up said therapeutic.

In a sixth aspect of the present technology, there is provided the use of an implantable device or valve according to the first or second aspect of the present technology in therapy or medicine.

Reference to a “smart valve” in the following description is intended to refer to a valve having control capability, integrated seamlessly with one or more biosensors.

Reference to a “biosensor” is intended to refer to an analytical device based on the specific recognition of an analyte such as a biochemical or chemical element in combination with a detector element for signal processing.

Reference to a “detector element” refers to a biotransducer, these terms are synonymous, and is intended to include any one or more of the following biotransducers such as an electrochemical, optical, electronic, electro-chemiluminescence, piezoelectric, gravimetric and pyroelectric biotransducer. Examples of an electrochemical biotransducer includes those based upon changes associated with enzymatic reactions, potentiometric values (such as ionic strength, pH, hydration and redox reactions), ion-channel switches due to cell membrane permeability.

Examples of optical biotransducers include those based on fluorescent changes. Examples of piezoelectric sensors include sensors using crystals that undergo elastic deformation when an electrical potential is applied to them.

It will be appreciated that the smart valves and the smart valve systems of the present disclosure find particular utility in the following fields of technology: food and beverage analysis; quality control and manufacture of food/drink and medicaments; monitoring for specific medical conditions, such as and without limitation diabetes, chemotherapy and implant rejection and wear; studies of biomolecules and their interactions; medical diagnosis and treatments; monitoring blood biochemistry; environmental monitoring such a water quality; and industrial process control.

Referring to FIG. 1, a smart microfluidics chip device 100 comprises a substrate 102 upon which an actuator layer 104 is formed with valves 106 connecting between the actuator layer 104 and a microfluidic chip 108. Biosensors 110 are provided in communication with the microfluidic chip 108. The microfluidic chip 108 comprises an inlet 112 shown as a tube having at one end a shutter 114 providing an access point for delivery of a reagent 116 into the microfluidic chip 108. An outlet 118 is connected to the microfluidic chip 108 enabling the removal of waste materials from the microfluidic chip 108 or the removal of the unauthenticated fluid. The smart microfluidics chip device 100 further comprises a control unit 120 which is coupled to the actuator layer 104 and may be a programmable microcontroller or a custom hardware specific to a user application. The control unit 120 is connected to a storage unit 122.

In operation, the smart microfluidics chip device 100 is implantable into a subject, for example a human body and used in diverse biomedical applications such as drug delivery, programmable personal health, monitoring and artificial dialysis, for example.

The smart microfluidics chip 100 once implanted can expose the inlet 112 and outlet 118 to the external world and fluid in the form of a drug or reagent or solution can enter the smart microfluidic chip 100 through inlet 112 under the control of the control unit 120, and waste fluid is extracted from outlet 118. To prevent contamination the inlet 112 exposed to the outer world comprise the shutter 114 which may be open or closed.

In embodiments, a device and method is provided to enable selective injection of fluids into devices such as microfluidic chips. Embodiments provide a mechanism to determine when the fluid injected into the microfluidics chip 108 is the correct fluid or not. Correct in the present context can mean that the injected fluid has the expected molecular concentration and expected fluid type. Accordingly, once the fluid is injected, the fluid is stored in a microchamber using a buffer reservoir where it can be checked for biosafety before letting the fluid flow directly to the microfluidics chip 108. FIG. 2 is a schematic diagram of a fluid delivery control device according to this embodiment of the present technology.

Referring to FIG. 2, a fluid control delivery device 200 comprises a housing 202 comprising a microchamber 204, an inlet 206 and microvalve 208.

The inlet 206 has an inlet shutter membrane 208 across its face controllable between open and closed states by way of a shutter control actuator (not shown) under the control of the control unit 120, shown in FIG. 1. The microvalve 208 is controllable between open and closed states by way of a valve control actuator (not shown) under the control of the control unit 120, shown in FIG. 1. Within the microchamber 204 are also one or more sensors 210, 212 which serve to sense and make detection of properties of a fluid 214 present within the microchamber 204.

In operation, once the fluid 214 is injected into the fluid control delivery device 200 it is received into the microchamber 204 acting as a buffer reservoir where the fluid 214 can be analysed and checked for biosafety by sensors 210, 212 before allowing passage to the microfluidics chip 108. Passage of the fluid 214 can be allowed by use of actuation options for ejecting fluid. Options include a helper-fluid or air or some type of mechanical compression of the chamber.

The microchamber 204 is equipped with sensors 210, 212 to monitor the following exemplary activities:
Fluid concentration and mass to check whether the injected reagents/drug concentrations and mass match the specification stored in the control unit's storage.
Recognition of the fluid type in order to prevent at least the following two risks:
   Unintentional biorisk, to ensure that the correct type of fluid is injected
   Intentional biorisk, to ensure that fluid injected is genuine and not a counterfeit in the case of drugs.
An optical biosensor which may be a combination of one or more LEDs and one or more photodetectors can be used to quantify fluid concentration/mass by measuring the intensity of light that has passed through the fluid sample and the intensity of the light before it enters the sample. Use of one LED and multiple optically filtered photodetectors each responding to different wavelengths, or one broad-spectrum photodetector and multiple LEDs of different wavelengths, or a combination thereof, additionally permits quantification of fluid composition such as the ratio of components that have different spectral absorption response.
To recognise the fluid type, the microchamber 204 can be equipped with an electrochemical biosensor which may be screen printed quantifying the PH level in addition to the optical biosensor. Data collected from the optical and electrochemical sensors (perhaps other sensor types too) can be relayed to the control unit 120 that can fuse the sensors to recognise the fluid type using predictive machine learning techniques.

If the injected fluid 214 meets criteria for safety, then the control unit 120 opens the microvalve 208 to let the injected fluid 214 enter the microfluidics chip channels. If the injected fluid 214 does not meet criteria for safety such as an incorrect type of fluid injected or the fluid concentration/mass is not in the right amount, then the control unit 120 will not open the microvalve.

Referring to FIG. 3, a schematic diagram of a fluid delivery control device 300 according to a third embodiment of the present technology comprises a pipe or other vessel acting as a chamber 302 having an inlet 304 and outlet 306. The inlet 304 is controlled at some position by an inlet shutter membrane 308 and the outlet 306 comprises a valve 310. A light emitting device 312 comprises a sensor array 314 disposed in an opposite position to a docking array 316 which comprises a protein dock array 318. Protein dock array 318 provides an analysis technique by which proteins are identified (using a protein microarray, or protein chip) and probed for interactions with a probe molecule in a high-throughput, parallel manner. The protein array 318 is connected to a CMOS gate circuitry 322 enabling determinations of the protein and concentrations to be measured.

In embodiments, the fluid control delivery device 300 may contain a fluid comprising an electrolytic solution and with an appropriate potential difference applied across the fluid such as by way of electrodes 320, sufficient electrical power may be provided by the flow of the fluid to power the actuation of the valve 310.

Referring to FIG. 4, a schematic diagram of a fluid delivery control device 400 according to a fourth embodiment comprises a pipe or other vessel acting as a conduit 402 located ahead in the flow pipeline to the smart microfluidics chip device 100 described in more detail in FIG. 1. The conduit 402 comprises a restricted flow nozzle 404 positioned at any point in the flow pipeline. In proximity to the restricted flow nozzle 404, sensors 406 can measure a change in pressure in order to determine the flow rate as in various flow measurement devices such as Venturi meters, Venturi nozzles and orifice plates. Additionally, an optical speed sensor 408 can determine the speed of the fluid flow. In embodiments if the flow rate is too high or too low compared to some predetermined threshold then a signal is communicated to close a microvalve 208 controllable between open and closed states by way of a valve control actuator (not shown) under the control of the control unit 120, as shown in FIG. 1.

FIG. 5 is a schematic diagram of a fluid delivery control device 500 according to a fifth embodiment of the present technology. Referring to FIG. 5, a housing 502 comprising sensor system 504 may accommodate a disposable syringe 506 or other fluid delivery device within the housing 502. Insertion of the syringe 506 into the housing 502 causes a valve 508 in the syringe 506 to align with the sensor system 504. The sensor system 504 verifies the validity and authenticity of the fluid and may trigger the valve 508 to open by way of an electromagnetic signal responsive to a geolocation marker or user authenticated response.

The valve 508 may be spring loaded and coated with a ceramic being by default in a closed state. The valve is therefore within the flow and upon insertion of the syringe 506 into the housing 502 it may be opened after approval. Therefore, the syringe 506 must be placed within housing 502 or it will not work.

In another variant, the spring loaded shutter as part of the disposable syringe is by default in an open state - and can be triggered by the non-disposable mechanism (mechanically or electromagnetically) to shut down (on-way, potentially non-resettable). The advantage to this arrangement is to actuate the higher energy spring with low energy (latches etc.)—and to maintain the pressure of the closed latch without adding further energy. Reference 510 is a magnet that is attached to a plunger to enable actuation by a coil 512.

Alternative embodiments and additions are considered to within the scope of the present disclosure. For example, with reference to FIG. 1, the shutter 114 may be closed in order to prevent ingress of contaminants or further delivery of reagent. Also, with reference to FIG. 1, the outlet 118 can be used to discharge waste material from the smart microfluidics chip device 100.

Alternatively, a latch as part of the disposable syringe prevents the syringe to be actuated by the user (mechanically etc)—ensuring that the syringe is locked by default. An electromagnet or similar mechanism remotely disengages/unlocks the latch after verification, so the syringe can be evacuated down by operator.

Further, the flow of fluid may be a continuous process under the control of a peristaltic pump. Control of the pump i.e. its ability to enable or disable fluid flow is equivalent to the opening and closing of a valve under the control of an actuator. Therefore, integrating a sensor around, for example, a flexible pipe disposed upstream from the pump may allow for control of delivery in much the same manner as described above given the ability for the sensor to communicate with the pump operation.

FIG. 6 is a schematic diagram of a fluid delivery control device 600 according to a sixth embodiment of the present technology. A non-disposable 600 apparatus with sensor circuit 614 actuates the flexible lever 610 that is locked in the notch 612 of the plunger 608 by default. The plunger 608 is sealed to the disposable syringe using O-ring 606. A magnet or metal plate (612) is attached to the flexible lever—allowing actuation by the electromagnet 614 (attached via 602 to the non-disposable housing 600) as a result of the approval by the sensor circuit 614 by performing a sensor reading on the contained liquid in the syringe using the contactless sensor 616.

The unlocking of the lever 610 then allows free movement of the plunger 608 in a downward motion—releasing the stored liquid.

Using notches, magnets or similar means in the syringe 604 the lever can switch bistable in the open position - thus only needing a short activation pulse to release the lever 610 from the plunger 608.

It will be clear to those skilled in the art that many improvements and modifications can be made to the foregoing exemplary embodiments without departing from the scope of the following claims.

1. A fluid delivery control device comprising;
at least one inlet portal to allow fluid passage into a chamber;
at least one outlet portal to allow fluid passage from the chamber;
at least one biosensor;
at least one actuator; and
wherein the at least one biosensor is in fluid communication with said fluid and is associated with a valve having actuator capability, the valve having actuator capability being in communication with sensor measured conditions upon which the valve permits or inhibits delivery of the fluid from the chamber.

2. The device according to claim 1 wherein the valve having actuator capability is a single unit or wherein the valve is separate from the actuator.

3. The device according to claim 1, wherein the valve having actuator capability in a single unit responds to a selected fluid parameter and actuates valve opening/closing in a single operation.

4. The device according to claim 1, comprising a plurality of valves for controlling fluid passage into and out of the chamber.

5. The device according to claim 1, including a microfluidic chip.

6. The device according to claim 5, wherein the chip is associated with a pump for assisting fluid flow.

7. The device according to claim 1, wherein the at least one biosensor is selected to detect changes in any one or more of the signals selected from the group of signals comprising: electrochemical, optical, electronic, electro-chemiluminescent, fluorescent, bioluminescent, piezoelectric, gravimetric and pyroelectric.

8. The device according to claim 1, wherein the biosensor is docked by marker molecules and is detectable by an array of light sensors, optionally wherein the light sensors are located outside of the chamber.

9. The device according to claim 1, which is implantable into a mammalian, bird, amphibian, arthropod, fish or reptile body either directly or within a biocompatible implant device.

10. The device according to claim 1, wherein in the inlet and outlet ports include a seal.

11. The device according to claim 1, further comprising the valve, the valve having a control system that includes:
at least one biosensor which is in fluid communication with said fluid and which provides empirical data to a processor; and
an integral or discrete actuator which is in communication with the processor, the processor being programmed with conditions upon which the valve permits or inhibits delivery of the fluid from a chamber.

12. (canceled)

13. A method of delivering an amount of fluid to a system the method comprising:
assessing a level of a moiety in a fluid sample in a chamber obtained from a fluid flow using the device or valve according to any preceding claim;
comparing the level of moiety present in the fluid derived from a readout of the device or valve to a standard value and/or a safe level;
allowing a programmed processor to determine if conditions are appropriate and feeding signals to a valve having actuator capability;
wherein, if conditions are inappropriate the valve will close to deny fluid passage to the system or if conditions are appropriate will allow fluid flow to the system.

14. A method according to claim 13, wherein the system is a mammalian body, a fluid line in the food and beverage industry, a fluid line in a chemical process, a fluid line in an industrial process or a fluid line in a fluid control mixing process.

15. The method according to claim 13, wherein determination of the moiety is either continuous or periodic.

16. The method according to claim 13, wherein the fluid includes a pre-mixed marker or a set of markers.

17. The method according to claim 16, wherein an identifier is generated from a combination of marker fluids types and/or concentration of marker fluids.

18. The method according to claim 17, wherein the identifier is read from a database and the valves remain close until a matching response is made in the database.

19. The method according to claim 18, wherein the database comprises a white or blacklist of fluids.

20. The method according to claim 16, wherein the fluid is a multiary fluid, whereby the absence or presence of a fluid type can encode one bit in a multibit value.

21. The method according to claim 13, wherein the fluid is selected from the group comprising a body fluid; blood, urine and plasma.

22. A method of assessing an amount of a medicament ex vivo to be administered to an individual comprising:
assessing a level of a moiety in a fluid sample in a chamber obtained from the medicament to be administered using the device or valve according to any one of claims 1 to 12;
comparing the level of moiety present in the fluid derived from a readout of the device or valve to a standard value and/or a safe level;
allowing a programmed processor to determine if conditions are appropriate and feeding signals to a valve having actuator capability;
wherein, if conditions are inappropriate valves will close to deny fluid passage to the system or if conditions are appropriate will allow fluid flow to the system.

23. A kit comprising the device or valve according to claim 1, having a chamber loaded with at least one therapeutic; a further reservoir of the therapeutic and an external/remote control system for topping up said therapeutic.

24. A device or valve according to claim 9, for use in therapy.
